(19) United States
(12) Patent Application Publication
(10) Pub. No.: US 2006/0140245 A1
(43) Pub. Date: Jun. 29, 2006

(54) Methods of making inductively heatble articles, induction furnaces and components and materials

(76) Inventors: Andrew Mark Wynn, Kiddeminster (GB); Nashim Imam, London (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/543,875

(22) PCT Filed: Jan. 27, 2004
(86) PCT No.: PCT/GB04/00345

§ 371 Date: Jul. 28, 2005

(30) Foreign Application Priority Data
Jan. 29, 2003 (GB) 0302108.6

(51) Int. Cl. H05B 6/02

(52) U.S. Cl. 373/138

(57) ABSTRACT

A method of forming an article comprises the steps of—a) forming an electrically conductive malleable composition to form an uncured shape; and b) inductively heating the shape to cure and harden it and thereby form the article.

This invention relates to inductively heatable articles, induction furnaces, components for induction furnaces, inductively heatable materials, and articles formed from said materials.

Inductive heating can be used in many applications to provide a source of heat without the need to connect wiring to the heat generating part. The present invention extends to the use of the materials claimed, in any article formed by induction heating or used in induction heating apparatus. The materials claimed may also have desirable thermal characteristics, and the present invention extends to the use of the claimed materials however formed.

Induction heating uses eddy currents produced by the interaction of a rapidly changing magnetic field with a conductive material. The rapidly changing magnetic field gives rise to induced currents in the conductive material, and these induced currents then produce resistive heating. The invention is exemplified in the following description by reference to induction furnaces, but it will be evident that the invention is not limited thereto.

Induction furnaces are frequently used in the metal processing industries to melt materials. When a material to be melted is sufficiently electrically conductive, that material can be directly heated through induction. ‘Rammed’, electrically non-conductive, refractory linings are typically used for metal containment in such applications. Alternatively, pre-formed clay-bonded SiC/graphite crucibles are frequently used. However, some materials do not “suscept” (interact with the electromagnetic field) very well, and among these are aluminium. For such materials heating has to be by an indirect route and typically this is by providing an electrically conductive crucible. As an example pre-formed carbon/silicon carbide based crucibles are used in such applications.

A problem with this approach is that it restricts the range of sizes and shapes of the furnace, and also inhibits the manufacture of large furnaces, since large crucibles are both difficult and expensive to make.

A further problem in such an arrangement, is that if a crucible cracks, the molten metal within the crucible can escape and damage the furnace. Accordingly when a crucible cracks it needs to be replaced completely with consequent cost.

The present invention provides a malleable composition that may have a resistivity low enough to effectively couple with the induction field of an induction furnace, and in doing so, be cured. The composition can contain a self-glazing additive to provide any necessary oxidation resistance. The malleable composition can be used to form a liner to an induction furnace in situ. It can also be used to repair cracks in such liners.

The composition also has improved thermal characteristics such that it can be used in conventional forming processes to advantage.

By malleable is meant that the material is sufficiently deformable and adherent that it is capable of being fashioned into shape by hammering or pressure. The material may be in the form of an adherent powder that adheres under pressure. Any method that is used for forming malleable materials can be adopted—(for example and without limitation-pressing, ramming, and rolling).

The scope of the invention is made apparent from the claims in the light of the following illustrative description with reference to the drawings, in which:—

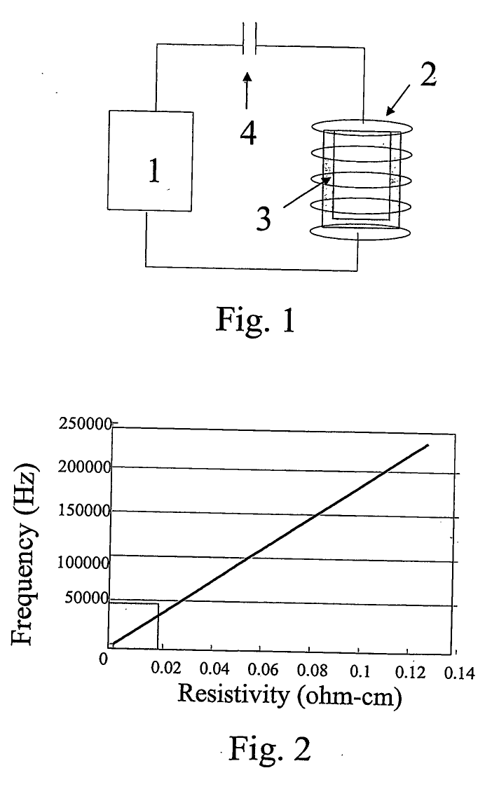

FIG. 1 is a schematic circuit diagram of an induction furnace;

FIG. 2 is a plot of frequency versus resistivity for a crucible as specified below;

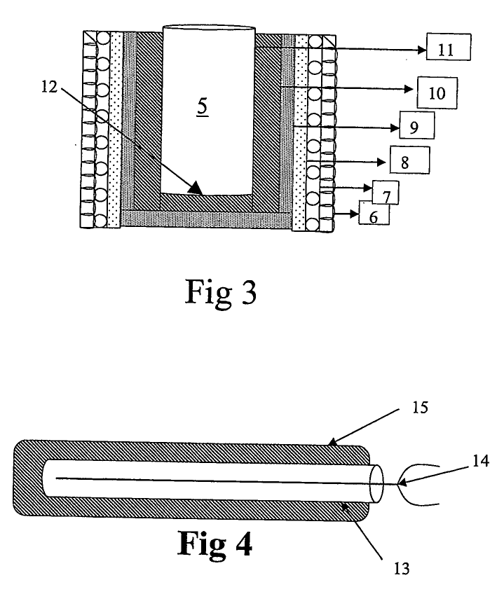

FIG. 3 is a diagram showing the forming of an induction furnace according to the invention;

FIG. 4 shows a sheathed thermocouple according to the invention; and

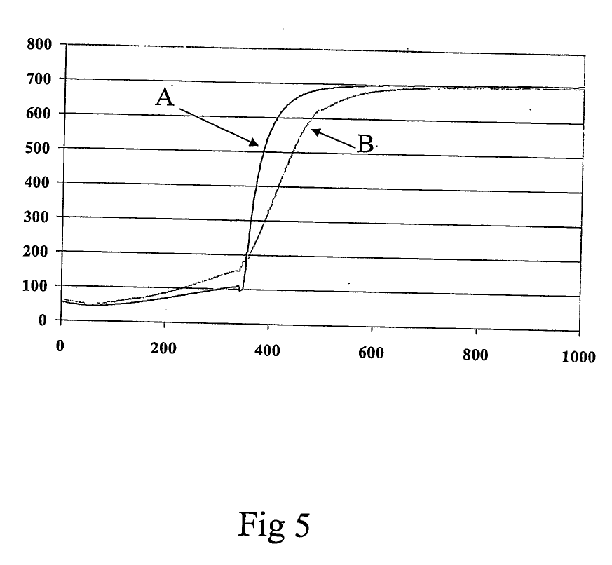

FIG. 5 shows the results of thermal response tests of the sheathed thermocouple of FIG. 4 and a more traditional sheathed thermocouple.

### INDUCTION FURNACE THEORETICAL CONSIDERATION

Eddy currents are made use of in induction furnaces. A schematic circuit diagram of a typical induction furnace layout is given in FIG. 1. Typically a source of medium frequency alternating current 1 supplies current to a water cooled coil 2 surrounding the crucible 3 to be heated. The circuit has a power factor correction capacitance 4.

The rapidly changing magnetic field of the coil induces EMFs which give rise to induced currents in those parts of the crucible and its contents which are conducting.

The measure of the ability of a coil to give rise to a back emf is known as the self inductance of the coil. It is defined by:

$$E = - L \frac{ⅆ I}{ⅆ t} \qquad ( 1 )$$

The induction will offer an opposition to the current flow due to the back emf and try to impede the changes which are producing it (Lenz's Law). This impedance is called the inductive reactance, X_{L}, which is given by:
X_{L}=ωL (2)

A capacitor in an AC circuit is continuously being charged and discharged. Increasing the frequency of the supply increases the rate at which the capacitor is charged and discharged and therefore, increases the reactive current. The applied voltage lags the current by π/2. Thus the impedance which a capacitor offers to current flow is called its reactance, X_{C}, and is given by:

$${X}_{C} = \frac{1}{ϖ C} \qquad ( 3 )$$

The effective resistance which the circuit shown in FIG. 1, as a whole offers to current flow is called the impedance, Z, and is defined by:
Z=\sqrt{R²+(X_{L}+X_{C})²} (4)

Both X_{L} and X_{C} depend on frequency and the frequency which causes the current to be maximum is called the resonant frequency and occurs when X_{L}=X_{C}.

$${f}_{o} = \frac{1}{2 π \sqrt{LC}} \qquad ( 5 )$$

The penetration depth of the eddy current is dependent upon both the resistivity of the material and the frequency of operation.

$$Penetration Depth ( cm ) = \sqrt{\frac{ρ}{4 π ω μ}} \qquad ( 6 )$$

Where:
ρ=resistivity of the material, ×10⁹
ω=2πf
μ=permeability ˜1.

Typical commercial induction furnaces operate at frequencies in the range 50 Hz to 10,000 Hz although higher frequencies are achievable. Ideally the crucible wall thickness should be greater than the penetration depth in order to couple efficiently within the crucible wall. The properties of a typical crucible for an induction furnace (e.g. an Excel™ crucible obtainable from Morganite Crucible Limited, Norton, England) are shown below:

| | |
|---|---|
| Resistivity (Ωcm) | 0.005 |
| Crucible Wall Thickness. | 4 cm |
| Operating Frequency (Hz) | 10,000 |

Taking the operating frequency at 10,000 Hz then the typical penetration depth for an Excel® crucible is calculated to be 3.55 cm. According to equation (6) the higher the resistivity of the material is, the greater the penetration, or the higher the required operating frequency, in order to couple within the crucible wall. The frequency can be increased by reducing the capacitance as shown in equation (5), i.e. by incorporating a variable capacitor.

However, reducing the capacitance will reduce the power factor. The power factor (pf) is defined as the ratio between real power (kW) and the total power supplied (kVA). Total power is made up of two components called Real Power (real work done) and reactive power (serves no real function).

Reducing the capacitance will increase the reactive component of power and hence reduce the power factor (pf).

Thus, if an electrically conductive malleable composition is to provide effective coupling with the induction field, the only options are to provide a low resistivity electrically conductive malleable composition such that it will couple at normal operating frequencies, or to increase the frequency to allow for a higher resistivity electrically conductive malleable composition.

FIG. 2 shows a plot of frequency required to couple at a depth of 3.72 cm for a 4 cm wall thickness crucible versus the resistivity of the material. As is demonstrated in the plot the greater the resistivity of the material, the greater the frequency necessary to couple within the crucible wall.

Therefore, for an electrically conductive malleable composition layer of 4 cm thickness to effectively couple with normal operating frequencies of 50 Hz to 10,000 Hz the resistivity of the electrically conductive malleable composition would need to be below about 0.0055 Ωcm. To couple at a typical frequency of about 3,000 Hz the resistivity of the electrically conductive malleable composition would need to be below about 0.002 Ωcm. This of course assumes that a malleable composition would have to be applied to a similar thickness as a crucible wall thickness. If thinner thicknesses are applied either the resistivity would have to be lower, or the operating frequency higher. Conversely, a thicker layer implies that a higher resistivity can be tolerated or lower frequencies used.

Electrically Conductive Malleable Material Requirements

In addition to a requirement for electrical conductivity, the electrically conductive malleable material has other requirements.

In use, crucibles manufactured from graphite and silicon carbide can be expected to hold molten substrates at temperatures as high as 1400° C., or in some cases higher, therefore a number of physical properties are required of them. These properties include flexural strength, thermal conductivity, oxidation resistance and erosion resistance.

Electrically conductive silicon carbide based crucibles are traditionally formed from a mixture of silicon carbide powder and graphite flakes bound together by the carbonised residue of a binder compound, for example a resin, pitch or tar. The manufacturing steps typically comprise several of the following steps:—
pressing the mixture of silicon carbide, graphite, and binder to form a green body
“fettling” the green body (e.g. machining the body to a final green shape, adding spouts or handling lugs)
curing the green body to remove volatiles from the binder and/or set the binder
firing the green body at a temperature and for a time sufficient to carbonise the binder
applying a glaze to the finished crucible to protect the body of the crucible against oxidation

Typically, the pressing step is by either isostatic pressing or by roller pressing (in which a roller presses the mixture against the inside of a mould).

Before firing, the binder holds together the “green” crucible to provide adequate mechanical strength for the handling and fettling. Once cured and fired, the binder carbonises to leave a residual carbon skeleton that contributes to the structure of the crucible.

The use of carbon precursors based on resin, pitch and tar in the manufacture of crucibles is coming under increasing pressure due to environmental, health and safety concerns. In the past, legislation associated with these matters has been a factor in the replacement of pitch and tar with phenol based resins such as novalac resins. There are now increasing health concerns with the use of phenol based binders, and legislation may eventually make their use uneconomical.

In use, the glaze applied to the crucible can be damaged through mechanical abuse, and such damage exposes the core of the carbon/silicon carbide crucible to attack (primarily through oxidation).

The above problems in the manufacture of crucibles are amplified when one is considering an electrically conductive malleable composition that has to be installed and fired in situ. Desirably the electrically conductive malleable composition, to provide performance comparable to a fired crucible, should:—
have a high thermal conductivity, when cured, to avoid “hot spots”
show oxidation resistance when cured
resist erosion when cured.

In addition, to make best use of its malleable nature, the electrically conductive malleable composition desirably should:—
minimise the amount of noxious vapours released
provide only minimal quantities of vapour on curing so as to reduce the risk of cracking or spalling
not require a separate glazing step to provide oxidation resistance
be capable of “self healing” so that damage to the glaze is repaired without specific attention
   Reduction of Noxious Vapour

Existing resin, pitch, or tar based binders would produce unacceptable quantities of noxious vapours. The applicants have realised that water based binders would be preferable, since these will minimise or nullify the generation of hydrocarbons during curing and firing. Several water based binders are possible, including sugars. Indeed the use of dextrine to provide some binding in the unfired state and provide carbon as a binder on firing is contemplated. However, the applicants have found that a water based carbon dispersion (for example a graphite dispersion) provides good binding activity to produce a coherent body, whilst not generating any hydrocarbons during firing.

Because the carbon is provided in a water based dispersed form it of necessity has a fine particle size and so has a high surface activity. The high surface activity means that the particles of carbon readily bind to the coarser particles of the material (e.g. graphite flakes and silicon carbide) and so act as a binder. A typical particle size of carbon in the dispersion is <5 μm, and preferably <2 μm to get good binding through electrostatic attraction, although colloidal sized particles (<1 μm) would provide higher surface activity and electrostatic attraction.

In tests, the applicants used two water based graphite dispersion (Metaflo 4000™, a water based graphite dispersion available from Rocol Limited of Leeds, England, normally used as a lubricant for hot metal working tools and a specially prepared graphite dispersion from Pilamec Ltd, Unit 40/41, Lydney Industrial Estate, Lydney, Gloustershire, GL15 4EJ) having the properties set out below.

In tests, the applicants have also found that the physical green binding strength which is an important criteria for the malleability of the mix is influenced by the viscosity of the binder which in turn is influenced by the graphite content.

| | Metaflo | |
|---|---|---|
| | 4000 ™ | Pilamec |
| Graphite content | ˜21% | ˜30% |
| Particle size | ˜50% <2 μm | ˜50% <8 μm |
| Viscosity at 25° C. | 2.5 mPA · s | 15.7 mPA · s |
| Specific gravity | 1.13 | 1.2 |

Such water based binder systems can be used generally for binding carbon and carbon/silicon carbide materials, so avoiding the use of more noxious components.

Green Binding

Green binding is an important criteria of the mix, as the mix should maintain its pre-formed shaped once rammed or pressed into any artefact without distortion or slumping. In addition to the use of high graphite content dispersed binder, in tests, the applicants have found that the addition of one or more clays—e.g. high absorbent/pliable clays such as bentonite, and/or borax (e.g. a colloidal borax solution), which would not evolve noxious fumes during heating, improved the green strength of the mix and improved adhesion and pliability of the mix. However, the applicant have also found that the addition of these clays increases the resistivity of the mix such that the amount had to be kept to a minimum. Typically additions of less than 2% were used.

Prevention of Cracking and Spalling

A water based binder will still release water on curing of the electrically conductive malleable composition, and that water could cause cracking or spalling. This is particularly so if heating is rapid as the water will all form steam at 100° C.

The applicants decided to use superabsorbers as an additive. Superabsorbers are very powerful hygroscopic polymeric materials, commonly used in baby's nappies and other absorbent sanitary towels (see for example WO9415651, WO9701003, and US2001047060). Superabsorbers are conventionally used in such applications as granulated materials or as woven or non-woven textiles.

When added as a fine powder to the electrically conductive malleable composition, typically at less than the 1% level, the applicants have found superabsorbers absorb water from the composition, and release it at a range of higher temperatures from 100° C. upwards. The material used by the applicants in tests was a sodium/potassium polyacrylate, which is a non-toxic white powder. The material was bought in bulk under the trade name Supersorp® from Huvec Klimaatbeheersing of Postbus 5426, 3299 ZG MAASDAM, Belgium.

Typically, superabsorbers are provided as a granulate. The powder used by the applicants was a fine powder with 75% between 75-150 μm. Preferred materials have 75% by weight or more of a size less than 150 μm.

Superabsorbers such as sodium polyacrylate are polymeric materials having a large number of hydrophilic groups that can bond with water. The present invention extends to any hygroscopic polymeric material, such as a superabsorber, that can absorb large quantities of water and release the water over a range of temperatures. Typically a superabsorber can absorb more than 5 grams of water per gram of material and absorbencies of >10 g/g, >15 g/g and >20 g/g are not unusual (see U.S. Pat. No. 5,610,220) and indeed absorbencies of >100 g/g are known for distilled water of 400-500 g/g and lower in salt solutions (e.g. 30-70 g/g in 0.9% NaCl solution). Preferred materials for the present invention have absorbencies for distilled water above 100 g/g, more preferably above 200 g/g.

Further applications of superabsorbers to drying refractory materials are set out in co-pending International Patent Application WO03/106371.

Self-Glazing and Self-Healing

The applicants decided that some self-glazing property would be advisable. Self-glazing is known for some ceramics. Typically a glass or a flux is included in the material so that on firing it can form a skin over the ceramic. Self glazing has rarely been used for carbon/silicon carbide materials in the past. Use of a glass or flux is however compatible with such materials. In particular, the applicants have found that incorporation of boron containing materials in a conventional crucible mix provides such self-glazing properties.

The applicants believe that the boron containing materials oxidise to form B₂O₃, which reacts with any other glass formers present to form a glaze. A particularly useful form of boron containing material is boron carbide, which gives the best results the applicants have found to date. Other boron containing materials which give a self glazing effect include boron nitride. Boron carbide is used as an anti-oxidant for refractory materials, as is boron nitride, but its use to form a glaze is unreported.

Because the material of the glaze is part of the electrically conductive malleable composition, damage to the glazed surface is healed through contact of the unglazed body with air.

Lowering Resistivity

As is discussed more fully below, lowering the resistivity of the electrically conductive malleable composition can be achieved by several means. These include the use of exfoliated graphite flakes, which have a high surface area and/or carbon fibre. In a typical green mix, electrical conductivity is provided by current passing from particle to particle within the mix. If the particles of the mix are of higher conductivity than any continuous phase (as is typically the case) then the bulk of the resistivity is accounted for by the need for current to jump from particle to particle.

An exfoliated graphite provides a high surface area so that current can be collected from and transferred to a large number of other conductive particles. This can reduce the number of particle/particle junctions that current has to cross and so reduce resistivity.

In similar fashion, carbon fibres can transfer current over long distances compared with the particle size of a typical green mix.

### EXAMPLES

A series of compositions were made having the compositions set out in Table 2 below based upon a base mix set out in Table 1 below. 5 kg of mix was mixed in a Z-blade mixer for 20 minutes. The mix was then rammed into an alumina crucible. The alumina crucible was then placed in a traditional induction furnace with an operating frequency of 3000 Hz.

TABLE 1

| Raw material | Wt % | Specification |
|---|---|---|
| Graphite flake | 34.1 | >84% C, 90% >180 μm, 10% <500 μm |
| Silicon carbide | 38.1 | >95% SiC, 50-70% 180-355 μm |
| Alumina coarse | 5.3 | >94% Al₂O₃, 65-90% 250-355 μm |
| Alumina fines | 0.5 | >60% Al₂O₃, 90% <75 μm |
| Ferrosilicon powder | 5.7 | 72-80% Si, 65% <53 μm |
| Silicon powder | 6.0 | >97% Si, 65% <53 μm |
| Borax | 4.1 | 80% <75 μm |
| Supersorp ® | 0.4 | See description above |
| Boron carbide | 3.8 | >95% B₄C, 95% <53 μm |
| Dextrine | 2.0 | See description above |
| +water based carbon | +15.0 | Metaflo 4000 ™ - see description above |
| binder | | |

Due to the low conductivity of the base mix (given in Table 1 and designated Mix A in Table 2), the lining did not suscept sufficient to cure. Instead the lining was used to melt cast iron at 1500° C. It was proposed that the heat from the metal would allow the mix to heat up and hence, self glaze.

Various methods were used to improve the conductivity of the green mix. These include the use of exfoliated graphite flakes, which have a high surface area and carbon fibre. Two types of exfoliated graphites were used, TimCal Graphite BNB90 with a surface area of 26.02 m²/g and Superior Graphite EX21 with a surface area of 21.68 m²/g. Around 5% of the graphite flakes was added to a standard mix as shown in Table 2.

TABLE 2

| | Base Mix | | | | | | | | |
|---|---|---|---|---|---|---|---|---|---|
| | A | B | C | D | E | F | G | H | I |
| +EX21 | | 5 | | | | | | 5 | 5 |
| +BNB90 | | | 5 | 5 | 5 | 5 | 5 | | |
| +3 mm fibres | | | | 0.05 | | 0.1 | | 0.1 | |
| +6 mm fibres | | | | | 0.05 | | 0.1 | | 0.1 |
| Resistivity Ωcm | 0.143 | 0.06 | 0.133 | 0.02 | 0.02 | 0.017 | 0.01 | 0.018 | 0.016 |

Another approach to improving the conductivity was the addition of carbon fibres. Two sizes of carbon fibres (Graphil™ 34-700) were used, 3 mm and 6 mm in length and added in 0.05% and 0.1% quantities. The fibres were dispersed in the mix using a coarse sieve prior to the addition of the water based carbon binder.

Investigative mixes were pressed into bars of dimension 153 mm×26 mm×15 mm and density 2.1 g/cm³. Due to the fragile nature of the pressed bars, which made electrical resistivity measurements difficult, the bars were cured to 150° C. to provide some handling strength prior to measurement. Resistivities were measured and the results are summarised at the foot of Table 2.

The addition of exfoliated graphite flakes had a marked impact to the conductivity of the base Mix A recipe (compare for example the resistivities of Mix A and Mix B). This in combination with the carbon fibres shown for Mix D to G further improves the conductivity. The more fibres in the mix the better the conductivity. A final value of resistivity of 0.01 Ωcm was achieved. According to the plot of frequency versus resistivity shown in FIG. 2, this would mean that the mix would couple at a frequency of 18 kHz for a 4 cm crucible wall thickness. The frequency is within an acceptable range, however, further improvements to the conductivity are still possible by using more conductive carbon fibres based on pitch/tar.

### Example 2

500 kg of mix I shown in Table 2 above was mixed in a high shear Morton Mixer. The mixing procedure is shown below.

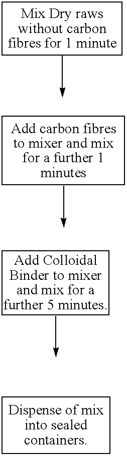

FIG. 3 shows a furnace arrangement in which furnace 5 comprises induction coils 6, cooling coils 7, slip plane 8, alumina protection blanket 9, rammed induction lining 10, and base lining 12. The mix was initially rammed using an air pressure hammer on the floor of the induction furnace to create a base lining 12 approximately 5 cm thick. A cardboard support cylinder 11 of diameter 30 cm was then placed on the inside of the induction furnace which was of diameter ˜48 cm and ˜71 cm deep. To provide extra protection to both the cooling coils 7 and induction coils 6 a ˜2.5 cm thick alumina fibre blanket 9 was placed against the insulating slip-plane 8 covering the cooling coils 7. The mix was rammed using an air pressure hammer in the ˜5 cm gap between the cardboard support cylinder 11 and the alumina blanket 9 covering the slip-plane 8. A rammed lining 10 of about ˜5 cm thick was created using this technique. With an operating frequency of 1900 Hz and power in the range 80 kW-100 kW, the mix was inductively heated to 1500° C. to both cure and fire the mix. The pre-fired lining was then used to melt iron at 1500° C.

### Example 3

In this application, the applicant took advantage of the malleability of the mix to isostatically press various foundry artefacts, for example thermocouple sheaths for non-ferrous applications. Unlike the inductive lining for such an application there is no real requirement for electrical conduction as the thermocouple sheath will not be heated by induction but merely thermal conduction. For this reason there were no carbon fibre additions. As thermal conduction plays a major part in the properties of the sheath, the presence of the exfoliated graphite was important.

12 kg of the base mix shown in Table 1 but using as water based binder Pilamec™ instead of Rocol™, and using 5% of an exfoliated graphite powder ABG1025 from Superior Graphite with a surface area of 18 m²/g as the exfoliated graphite additive, was mixed in a small plough shear mixer (miniature version of the Morton Mixer) using the mixing procedure shown below.

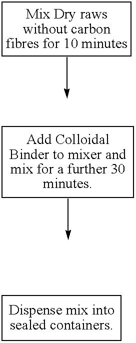

FIG. 4 shows a schematic diagram of a sheathed thermocouple comprising a steel former 13, thermocouple 14 and isostatically pressed sheath 15. The mix was isostatically pressed around the hollow steel former 13, (21.5 mm diameter and 463 mm long), to a pressure of ˜13.8 MPa [2000 PSI] to create a sheath 15 of 44 mm outer diameter.

The sheath was then cured to 150° C. for 2 hours to provide some green strength. The whole assembly was finally fired to 1025° C. to activate the self-glazing properties of the mix.

Thermal response tests in molten aluminium of the sheathed thermocouple, and of a similar thermocouple made from a more traditional crucible mix were conducted. The tests consisted of preheating the sheathed thermocouples to and plunging them into molten aluminium at ˜700° C. The tests showed [see FIG. 5] that the rammable mix gave a quicker response time (line A) than the traditional crucible mix (line B), reaching the temperature of the melt sooner despite being preheated to a lower temperature. This indicates a significantly higher thermal conductivity.

Alternative Curing Methods

Providing a malleable composition that has an adequate electrical conductivity in the green state to cure completely of itself is possible. However it can prove advantageous, particularly where the malleable composition is insufficiently conductive in the green state to couple efficiently, to place an electrically conductive former (e.g. a steel shell) inside the lined furnace and heat this shell by induction. This can act to indirectly heat and cure the malleable composition. In the curing process the conductivity will rise, so that the cured lining will couple better than in the green.

In addition to usage in traditional induction furnaces, the associated malleable characteristics with low resistivity will also permit the mix to be used in a range of other applications where induction heating is a requirement. For example the material may be used to form inductively heatable tube furnaces for treating material passing through the tubes.

The material results in articles having an improved susceptibility in comparison with conventional materials. The “Q” value of an article is defined as the ratio of the total power KVA to the real power KW or conversely the inverse of the power factor, e.g. for a work piece resulting in a “Q” of 5, to generate 100 KW in the work piece you would need a total power of 500 KVA in the work coil.

Hence the lower the “Q” value, the lower the reactive power required in the coils to generate the same power in the work piece. Commercial induction crucibles result in a “Q” value of around 10, whereas the “Q” value of a crucible made with the materials of the present invention has been shown to be around 5.

Crucibles according to the present invention are thus more efficient than a conventional crucible. The same applies to other inductively heated articles.

Equally the malleable characteristics of the mix will allow the mix to be pre-formed into any artefacts such as crucibles or thermocouple sheaths via a range of pressing techniques typically isostatic pressing or uniaxial pressing.

The thermal characteristics of the material provided by various carbon and carbide components would also allow the pre-formed artefacts to be fired by any other means such as gas or electric firing. In the latter, oxidation resistance can be provided by either the traditional glazing route or self glazing.

1. A method of forming an article comprising the steps of:—
(i) forming an electrically conductive malleable composition to form an uncured shape; and
(ii) inductively heating the shape to cure and harden it and thereby form the article.

2. A method, as claimed in claim 1, in which the article is an inductively heatable part of a heating apparatus.

3. A method, as claimed in claim 1, in which the inductively heatable part is the lining to an induction furnace.

4. A method, as claimed in claim 1, in which the electrically conductive malleable composition has a resistivity of less than 0.04 Ω·cm.

5. A method, as claimed in claim 3, in which the electrically conductive malleable composition has a resistivity of less than 0.02 Ω·cm.

6. A method, as claimed in claim 1, in which the electrically conductive malleable composition includes as an ingredient graphite flakes.

7. A method, as claimed in claim 6, in which the amount of graphite flakes is greater than 20% by dry weight of the electrically conductive malleable composition.

8. A method, as claimed in claim 7, in which the amount of graphite flakes is greater than 30% by dry weight of the electrically conductive malleable composition.

9. A method, as claimed in claim 6, in which the flake graphite is or includes an exfoliated flake graphite.

10. A method, as claimed in claim 1, in which the electrically conductive malleable composition includes as an ingredient silicon carbide.

11. A method, as claimed in claim 10, in which the amount of silicon carbide is greater than 20% by dry weight of the electrically conductive malleable composition.

12. A method, as claimed in claim 11, in which the amount of silicon carbide is greater than 30% by dry weight of the electrically conductive malleable composition.

13. A method, as claimed in claim 1, in which the electrically conductive malleable composition includes as an ingredient a water based carbon dispersion binder.

14. A method, as claimed in claim 13, in which the water based carbon dispersion binder is or includes a graphite.

15. A method, as claimed in claim 14, in which the graphite is a colloidal graphite.

16. A method, as claimed in claim 13, in which the carbon provided by the water based carbon dispersion binder is present in amount less than 20% by dry weight of the electrically conductive malleable composition.

17. A method, as claimed in claim 1, in which the electrically conductive malleable composition includes as an ingredient carbon fibres.

18. A method, as claimed in claim 1, in which the electrically conductive malleable composition includes as an ingredient a hygroscopic polymeric material capable of retaining water in the mixture over a range of temperatures above the boiling point of water.

19. A method, as claimed in claim 18, in which the hygroscopic polymeric material has an absorbency of more than 5 grams of water per gram of material.

20. A method, as claimed in claim 19, in which the hygroscopic polymeric material has an absorbency of more than 10 grams of water per gram of material.

21. A method, as claimed in claim 20, in which the hygroscopic polymeric material has an absorbency of more than 100 grams of water per gram of material.

22. A method, as claimed in claim 21, in which the hygroscopic polymeric material has an absorbency of more than 200 grams of water per gram of material.

23. A method, as claimed in claim 18, in which the hygroscopic polymeric material is a polyacrylate.

24. A method, as claimed in claim 18, in which the hygroscopic polymeric material comprises a fine powder with 75% by weight or more of a size less than 150 μm.

25. A method, as claimed in claim 1, in which the electrically conductive malleable composition includes as an ingredient a self-glazing constituent.

26. A method, as claimed in claim 25, in which the self-glazing constituent is or includes a boron containing material.

27. A method, as claimed in claim 26, in which the self-glazing constituent is or includes boron carbide.

28. A method, as claimed in claim 1, in which the electrically conductive malleable composition is a rammable composition and is rammed into a former to form the article.

29. A method, as claimed in claim 1, in which step b) comprises at least in part indirect heating by an inductively heated former.

30. A malleable composition comprising in dry weight percent of the composition:—
graphite flakes>20%
silicon carbide>20%
and further comprising a water based carbon dispersion binder.

31. A malleable composition, as claimed in claim 30, in which the water based carbon dispersion binder is or includes a graphite.

32. A malleable composition, as claimed in claim 31, in which the graphite is a colloidal graphite.

33. A malleable composition, as claimed in claim 30, in which the carbon provided by the water based carbon dispersion binder is present in amount less than 20% by dry weight of the malleable composition.

34. A malleable composition, as claimed in claim 30, in which the amount of graphite flakes is greater than 30% by dry weight of the malleable composition.

35. A malleable composition, as claimed in claim 30, in which the flake graphite is or includes an exfoliated flake graphite.

36. A malleable composition, as claimed in claim 30, in which the malleable composition includes as an ingredient carbon fibres.

37. A malleable composition, as claimed in claim 30, in which the malleable composition includes as an ingredient a hygroscopic polymeric material capable of retaining water in the mixture over a range of temperatures above the boiling point of water.

38. A malleable composition, as claimed in claim 30, in which the malleable composition includes as an ingredient a self-glazing constituent.

39. A malleable composition, as claimed in claim 38, in which the self-glazing constituent is or includes a boron containing material.

40. A malleable composition, as claimed in claim 39, in which the self-glazing constituent is or includes boron carbide.

41. A malleable composition, as claimed in claim 30, in which the malleable composition comprises a green binding additive.

42. A malleable composition, as claimed in claim 41, in which the green binding additive comprises one or more clays.

43. A malleable composition, as claimed in claim 41, in which the green binding additive comprises borax.

44. An uncured shape formed from the malleable composition of claim 30 to 43.

45. An article formed by curing a shape as claimed in claim 44.

46. An article as claimed in claim 45, in which the article is an inductively heatable part of a heating apparatus.

47. An induction furnace lined with an inductively cured and hardened electrically conductive malleable composition formed by the method of claim 1.

48. A method of binding carbon or carbon/silicon carbide materials comprising the use of a water based carbon dispersion binder.

49. A method, as claimed in claim 48, in which the water based carbon dispersion binder is or includes a graphite.

50. A method, as claimed in claim 49, in which the graphite is a colloidal graphite.
